(19) United States
(12) Patent Application Publication
(10) Pub. No.: US 2024/0045926 A1
(43) Pub. Date: Feb. 8, 2024

(54) HIERARCHICAL OPTIMIZATION OF TIME-SERIES FORECASTING MODEL

(71) Applicant: International Business Machines Corporation, Armonk, NY (US)

(72) Inventors: Arindam Jati, Bangalore (IN); Vijay Ekambaram, Chennai (IN); Sumanta Mukherjee, Bangalore (IN); Brian Leo Quanz, YORKTOWN HEIGHTS, NY (US); Wesley M. Gifford, YORKTOWN HEIGHTS, NY (US); Pavithra Harsha, White Plains, NY (US)

(21) Appl. No.: 17/879,538

(22) Filed: Aug. 2, 2022

(51) Int. Cl. G06K 9/62; G06N 20/00

(52) U.S. Cl. CPC G06K 9/6256; G06K 9/6219; G06N 20/00

(57) ABSTRACT

An example operation may include one or more of storing a hierarchical time-series data set in memory, initially training a first time-series forecasting model based on a lower level of time-series data in the hierarchical data set, training a second time-series teaching forecasting model based on an upper level of time-series data from the hierarchical data set which includes an additional level of aggregation with respect to the lower level of time-series data, optimizing one or more parameters of the initially trained first time-series forecasting model based on predicted outputs from the trained second time-series forecasting model in comparison to predicted outputs from the initially trained first time-series forecasting model, and storing the modified first time-series forecasting model in the memory.

### BACKGROUND

Time-series forecasting is a process in which a machine learning model predicts a future observation (e.g., a forecasted data value or distribution of data values) likely to occur in the future based on historical time-stamped data. Machine learning algorithms such as regression, random forests, neural networks, support vector machines, and the like, can be applied to time-series data and used as time-series forecasting algorithms. A traditional training process for a time-series forecasting model is referred to as a “hold-out” method in which the training data is split into different data sets including a first data set for training and a second data set for validating the trained model. During the testing phase, the user may manually make changes to the time-series forecasting model to optimize parameters.

However, the traditional hold-out method has a number of drawbacks. First, the training data is split into two sets resulting in less input data being used to train the machine learning model. In many cases, this can lead to a model that is less accurate since it is not being trained on all of the input data. Another problem is that the traditional training process for a time-series forecasting model relies on the lowest level of time-series data from a hierarchical data set. The lowest-level time-series data is typically the most sporadic/sparse which again leads to a model that is not as accurate (makes poor predictions, etc.). Another problem is that mismatch between the held-out validation set and the actual test set (unknown) can lead to poor generalizability of the time series forecasting model, because the hyperparameters of the forecasting model can be specifically tuned to that held-out validation set.

### SUMMARY

One example embodiment provides an apparatus that includes a memory configured to store a hierarchical time-series data set, and a processor configured to one or more of initially train a first time-series forecasting model based on a lower level of time-series data in the hierarchical data set, train a second time-series teaching forecasting model based on an upper level of time-series data from the hierarchical data set which includes an additional level of aggregation with respect to the lower level of time-series data, optimize one or more parameters of the initially trained first time-series forecasting model based on predicted outputs from the trained second time-series forecasting model in comparison to predicted outputs from the initially trained first time-series forecasting model, and store the optimized first time-series forecasting model in the memory.

Another example embodiment provides a method that includes one or more of storing a hierarchical time-series data set in memory, initially training a first time-series forecasting model based on a lower level of time-series data in the hierarchical data set, training a second time-series teaching forecasting model based on an upper level of time-series data from the hierarchical data set which includes an additional level of aggregation with respect to the lower level of time-series data, optimizing one or more parameters of the initially trained first time-series forecasting model based on predicted outputs from the trained second time-series forecasting model in comparison to predicted outputs from the initially trained first time-series forecasting model, and storing the optimized first time-series forecasting model in the memory.

A further example embodiment provides a computer-readable medium comprising instructions, that when read by a processor, cause the processor to perform one or more of storing a hierarchical time-series data set in memory, initially training a first time-series forecasting model based on a lower level of time-series data in the hierarchical data set, training a second time-series teaching forecasting model based on an upper level of time-series data from the hierarchical data set which includes an additional level of aggregation with respect to the lower level of time-series data, optimizing one or more parameters of the initially trained first time-series forecasting model based on predicted outputs from the trained second time-series forecasting model in comparison to predicted outputs from the initially trained first time-series forecasting model, and storing the optimized first time-series forecasting model in the memory.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a diagram illustrating a cloud computing environment that interacts with various devices according to an example embodiment.

FIG. 2A is a diagram illustrating abstraction model layers of a cloud computing environment according to an example embodiment.

FIG. 2B is a diagram illustrating a process of generating a student model and a teacher model from a hierarchical data set according to an example embodiment.

FIGS. 3A-3C are diagrams illustrating examples of a permissioned network according to example embodiments.

FIG. 3D is a diagram illustrating machine learning process via a cloud computing platform according to an example embodiment.

FIG. 3E is a diagram illustrating a quantum computing environment associated with a cloud computing platform according to an example embodiment.

FIGS. 4A-4B are diagrams illustrating a process of training a time-series forecasting model based on hierarchical knowledge distillation (HKD) according to example embodiments.

FIG. 5 is a diagram illustrating a method of training a time-series forecasting model according to an example embodiment.

FIG. 6 is a diagram illustrating an example of a computing system that supports one or more of the example embodiments.

### DETAILED DESCRIPTION

It is to be understood that although this disclosure includes a detailed description of cloud computing, implementation of the teachings recited herein is not limited to a cloud computing environment. Rather, embodiments of the present invention are capable of being implemented in conjunction with any other type of computing environment now known or later developed.

The example embodiments are directed to a model training environment, such as a cloud platform, web server, or other host, which may train and host time-series forecasting models. As referred to herein, a time-series forecasting model may be a machine learning model such as a regression model, a neural network, a support vector machine, and the like. The model may be trained to predict future observations for time-series data based on historical values of the time-series data set. However, rather than split-up the training data into a training data set and a test data set which is held-off for later, the example embodiments introduce the concept of hierarchical knowledge distillation (HKD) for time-series forecasting.

According to various embodiments, a “teacher” model may be generated and used to enhance or otherwise optimize parameters/hyperparameters of a time-series forecasting model being trained, also referred to herein as a “student” model. In the examples herein, the time-series models are trained using hierarchical time-series data. In particular, the student model may be trained based on a lowest-level of a hierarchical time-series data set (e.g., leaf node data, etc.) while the teacher model may be trained on upper-level time-series data (e.g., closer to the root node and including the root node, etc.).

The lowest-level time series data represents the most sparse and sporadic reading/measuring of the data. For example, in a hierarchical time-series data set that includes sales/month by a company, the lowest-level of the hierarchical time-series sales data may be sales volume by person/employee. Meanwhile, a next-lowest level of the hierarchical time-series sales data set may include sales volume by store location. In this next-lowest level, a time-series data point (store level) is generated by aggregating together multiple time-series data points (multiple people from the person level) from the hierarchical time-series data set to create a single time-series data point in the next-lowest level of the time-series data. The hierarchies may continue upward with a state-level sales in which a time-series data point is created by aggregating multiple time-series data points from the store-level. A next level in the hierarchy may include East Coast and West Coast, which may include time-series data points. The root of the hierarchical time-series data set may include a single value that is created by aggregating the time-series values from the next-level below.

By training the teacher model using higher-level time-series data from the hierarchical time-series data set, the teacher model may capture different patterns and trends within the data due to the differences in aggregation with the student motel which is trained on the lower level of the hierarchical time-series data set. Furthermore, the teacher model can be used to distill knowledge to the student model. For example, the teacher model and the student model may generate predictions on a test data set and use differences in divergence to optimize parameters and/or hyperparameters of the student model based on the predictions made by the teacher model. In some embodiments, the host platform may use the teacher model's predictions as a substitute for ground truth of the student model's predictions.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Examples of cloud computing characteristics that may be associated with the example embodiments include the following.

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Examples of service models that may be associated with the example embodiments include the following:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Examples of deployment models that may be associated with the example embodiments include the following:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

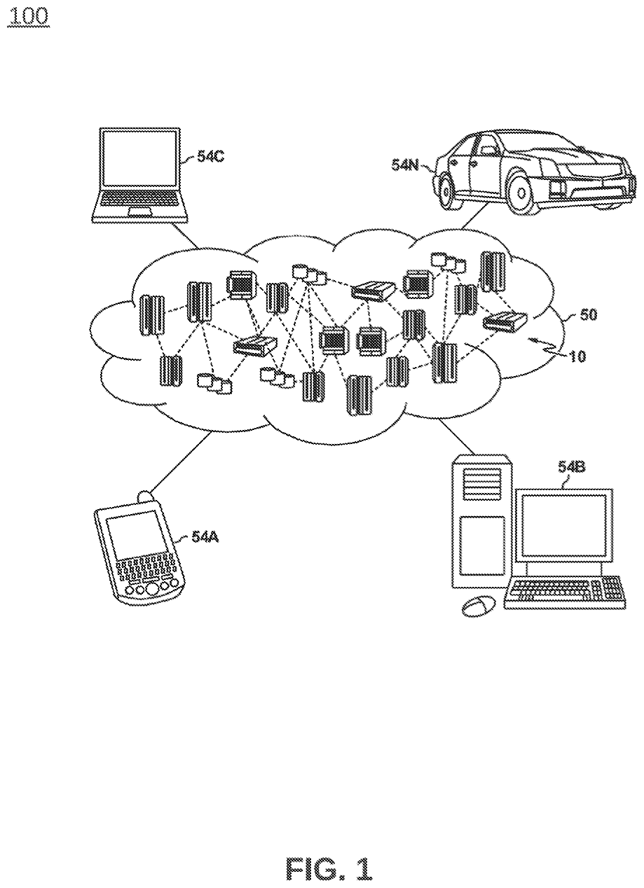

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that cloud computing nodes 10 and cloud computing environment 50 can communicate with any type of computerized device over any type of network and/or network addressable connection (e.g., using a web browser).

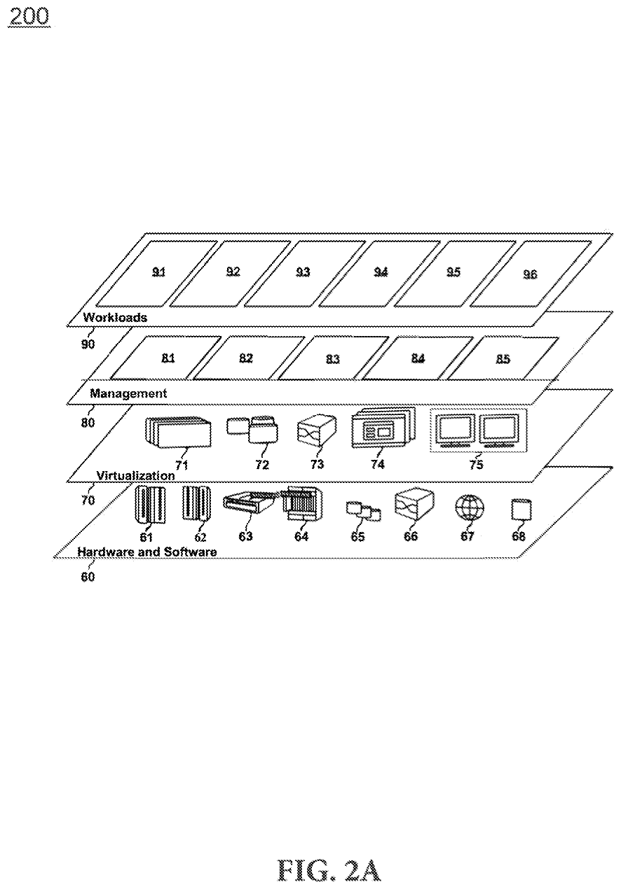

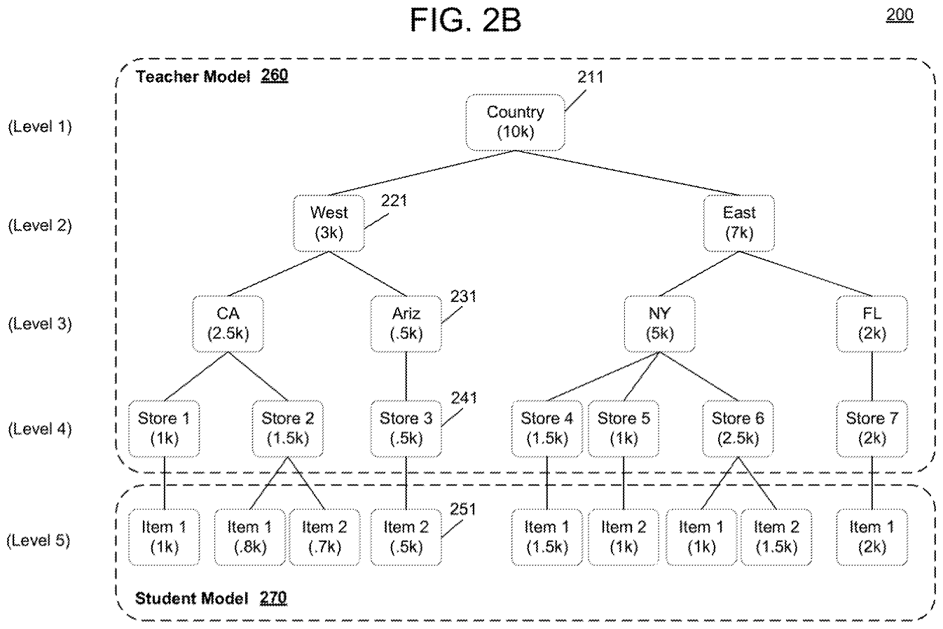

Referring now to FIG. 2A, a set of functional abstraction layers provided by cloud computing environment 50 FIG. 1) is shown. It should be understood in advance that the components, layers, and functions shown in FIG. 2A are intended to be illustrative only and embodiments of the invention are not limited thereto. As depicted, the following layers and corresponding functions are provided: Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workload layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and batch scoring 96.

FIG. 2B illustrates an example of a student model and a teacher model in accordance with example embodiments. A group of time-series data may have a hierarchy associated with it. For example, sales of a country may have a value 211 in the hierarchical time-series data set which corresponds to the root value or the top value in the hierarchy. Also, the sales of an item may be broken up into regions as denoted by data value 221, then broken up into states as denoted by data value 231, then broken up into store locations as denoted by data value 241, and then broken up into item types as denoted by data value 251. As you move from top to bottom in the hierarchical time-series data set, each level in the hierarchy divides the data into smaller subsets using different data attributes such as location to divide the sales data. Likewise, as you move from bottom to top in the hierarchical time-series data set, each level adds aggregation to data from the lower level creating less subsets of data.

Referring to FIG. 2B, a hierarchical time-series data set includes five levels of data starting with a root level (level 1) which corresponds to a sales value of all items within a country denoted as the data value 211. The next level down (level 2) divides the sales value for the country as a whole into sales for regions (i.e., East and West) as noted by the data value 221, the next level down (level 3) divides the sales by region into sales by states as noted by data value 231, the next level down (level 4) divides the sales by states into sales by stores as noted by the data value 241, and the last level down (level 5) divides the sales by stores into sales by item as noted by the data value 251.

According to various embodiments, a student model 270 (i.e., a time-series forecasting model) may be trained using the lowest-level time-series data (level 5). The lowest level of the time-series data may be the most sporadic, however, it is also the most fine-grained making it of potential value and importance in helping a machine learning model identify patterns within the data. However, such a narrow focus may prevent the machine learning model from gathering more course-grained insights from the higher-level time series data. Meanwhile, a teacher model 260 may be trained based on higher level time-series data in the hierarchical time-series data set.

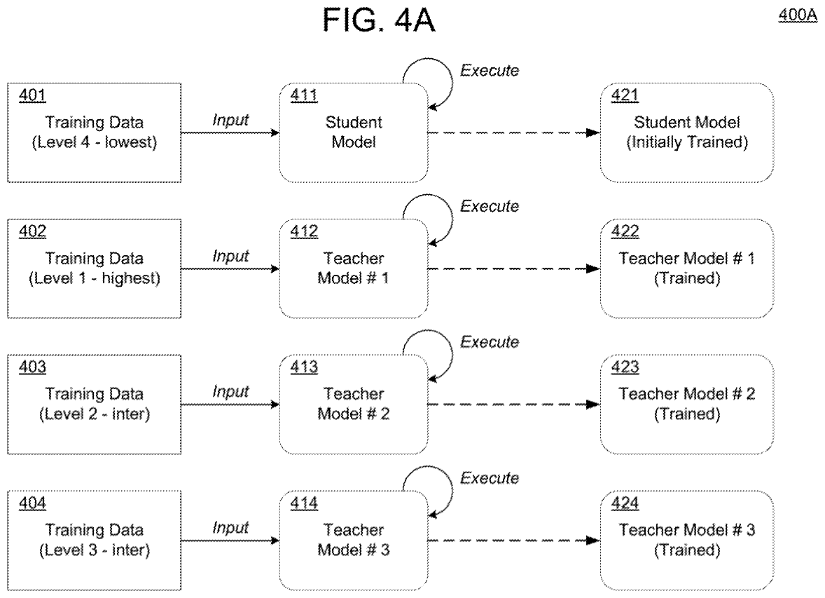

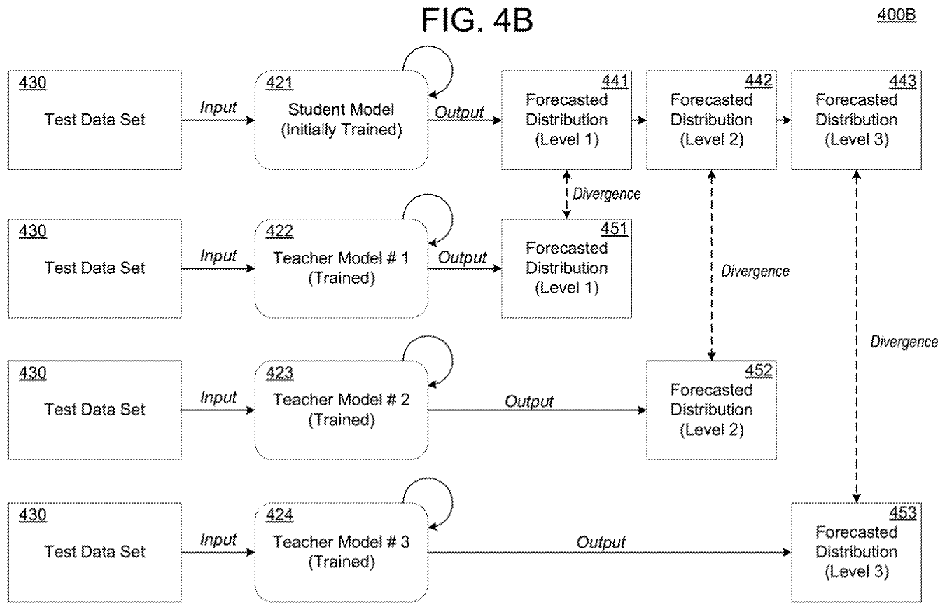

In this example, the teacher model 260 is trained using levels 1-4 of the hierarchical time-series data set, but it should be appreciated that the teacher model 260 may be trained using any of the upper levels of the hierarchical time-series data set, and not all of the hierarchical time-series data set. For example, just level 3 data may be used to train the teacher model 260. As another example, level 2 and level 3 data may be used to train the teacher model 260, etc. Also, it should be appreciated that the student model 270 and the teacher model 260 may both include the same algorithm for performing machine learning to start with. Due to the trainings on different hierarchies of data in the time-series data set, the algorithms will be adjusted differently resulting in differences in predictive capabilities between the student model 260 and the teacher model 270. For example, the teacher model 270 may initially be more accurate than the student model 260. Therefore, as further described in the examples of FIGS. 4A-4B, knowledge from the teacher model 260 may be transferred (i.e., distilled) to the student model 260.

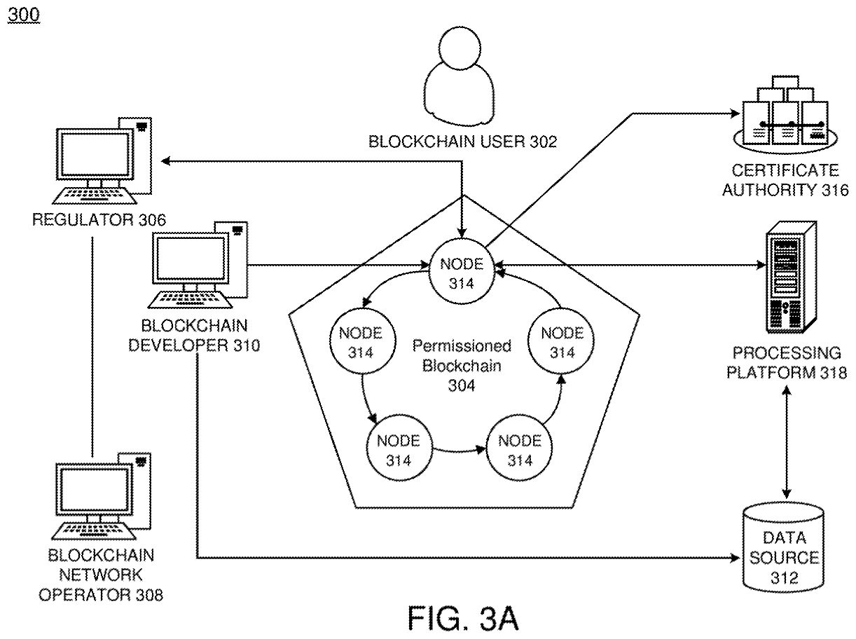

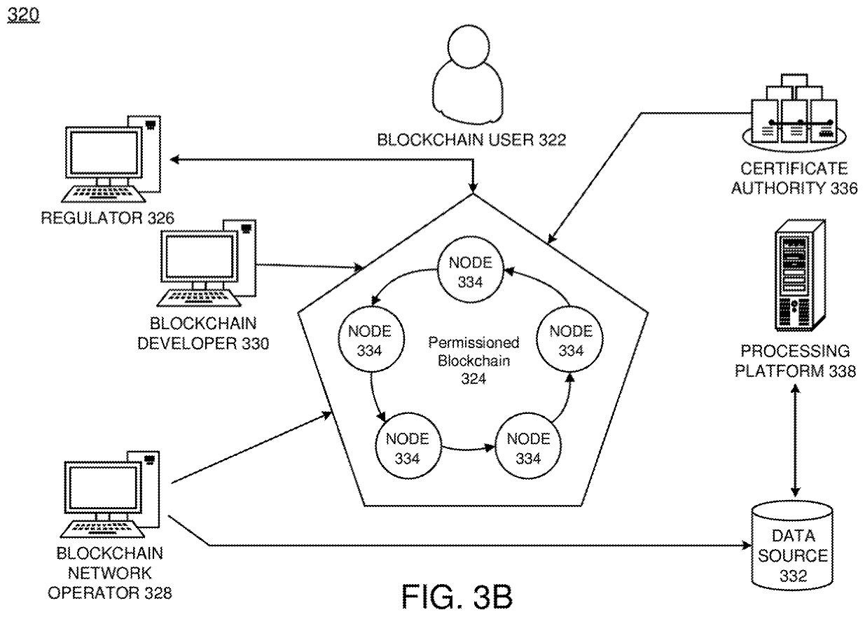

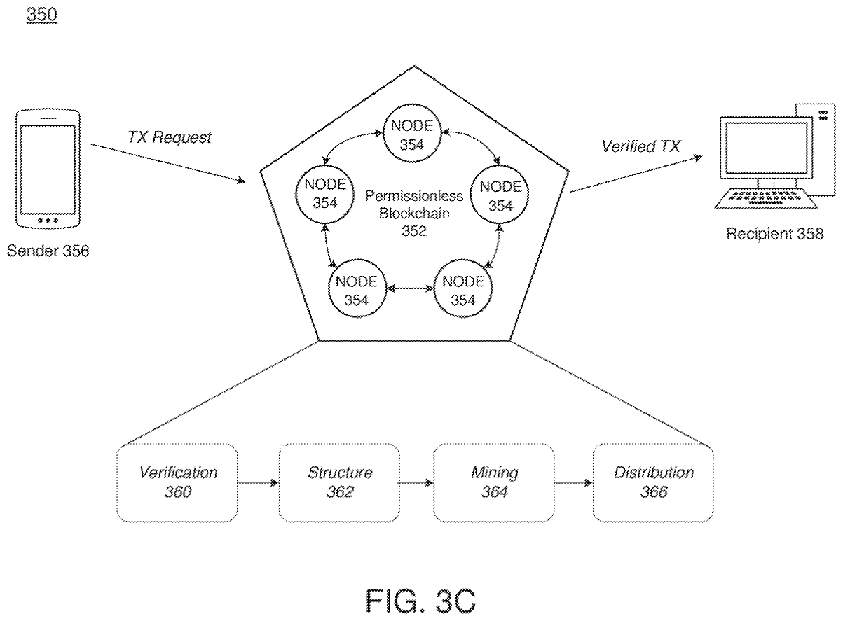

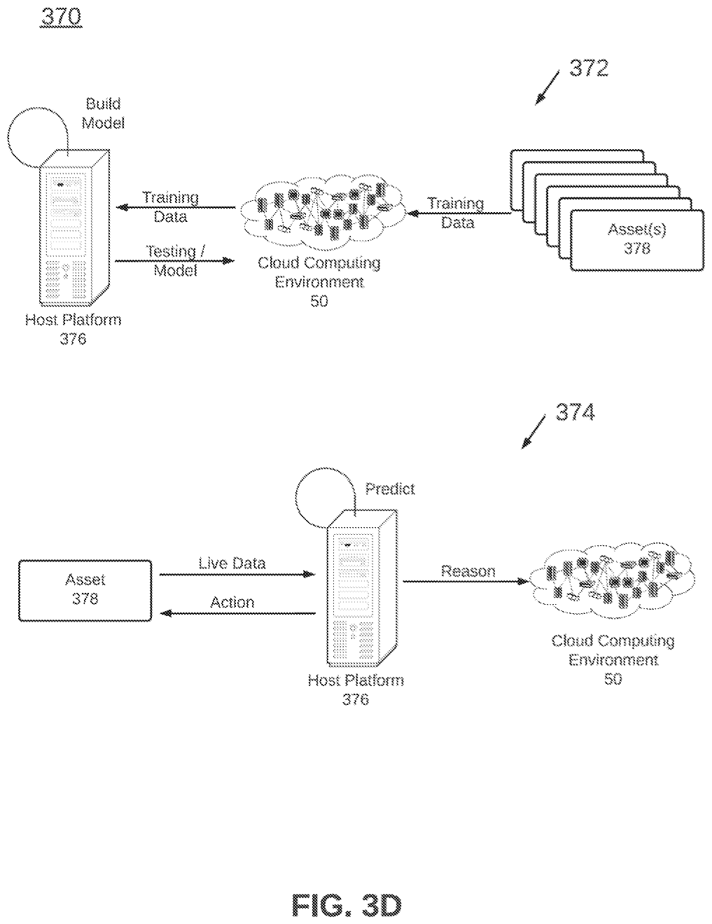

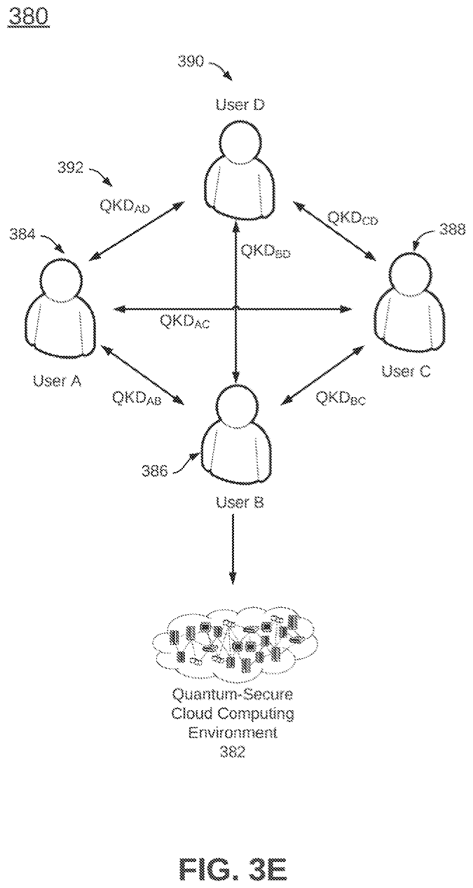

FIGS. 3A-3E provide various examples of additional features that may be used in association with the cloud computing environment described herein. These examples should be considered as additional extensions or additional examples of the embodiments described herein.

FIG. 3A illustrates an example of a permissioned blockchain network 300, which features a distributed, decentralized peer-to-peer architecture. The blockchain network may interact with the cloud computing environment 50, allowing additional functionality such as peer-to-peer authentication for data written to a distributed ledger. In this example, a blockchain user 302 may initiate a transaction to the permissioned blockchain 304. In this example, the transaction can be a deploy, invoke, or query, and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client”. An auditor could be restricted only to querying the ledger whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query, and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client”. An auditor could be restricted only to querying the ledger whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains which require permission to join, anyone can join a permissionless blockchain. For example, to join a permissionless blockchain a user may create a personal address and begin interacting with the network, by submitting transactions, and hence adding entries to the ledger. Additionally, all parties have the choice of running a node on the system and employing the mining protocols to help verify transactions.

FIG. 3C illustrates a process 350 of a transaction being processed by a permissionless blockchain 352 including a plurality of nodes 354. A sender 356 desires to send payment or some other form of value (e.g., a deed, medical records, a contract, a good, a service, or any other asset that can be encapsulated in a digital record) to a recipient 358 via the permissionless blockchain 352. In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters the nodes verify 360 the transaction based on rules (which may be pre-defined or dynamically allocated) established by the permissionless blockchain 352 creators. For example, this may include verifying identities of the parties involved, etc. The transaction may be verified immediately or it may be placed in a queue with other transactions and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256 bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution, the successfully validated block is distributed through the permissionless blockchain 352 and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

FIGS. 3D and 3E illustrate additional examples of use cases for cloud computing that may be incorporated and used herein. FIG. 3D illustrates an example 370 of a cloud computing environment 50 which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 3D, a host platform 376 builds and deploys a machine learning model for predictive monitoring of assets 378. Here, the host platform 366 may be a cloud platform, an industrial server, a web server, a personal computer, a user device, and the like. Assets 378 can be any type of asset (e.g., machine or equipment, etc.) such as an aircraft, locomotive, turbine, medical machinery and equipment, oil and gas equipment, boats, ships, vehicles, and the like. As another example, assets 378 may be non-tangible assets such as stocks, currency, digital coins, insurance, or the like.

The cloud computing environment 50 can be used to significantly improve both a training process 372 of the machine learning model and a predictive process 374 based on a trained machine learning model. For example, in 372, rather than requiring a data scientist/engineer or another user to collect the data, historical data may be stored by the assets 378 themselves (or through an intermediary, not shown) on the cloud computing environment 50. This can significantly reduce the collection time needed by the host platform 376 when performing predictive model training. For example, data can be directly and reliably transferred straight from its place of origin to the cloud computing environment 50. By using the cloud computing environment 50 to ensure the security and ownership of the collected data, smart contracts may directly send the data from the assets to the individuals that use the data for building a machine learning model. This allows for sharing of data among the assets 378.

Furthermore, training of the machine learning model on the collected data may take rounds of refinement and testing by the host platform 376. Each round may be based on additional data or data that was not previously considered to help expand the knowledge of the machine learning model. In 372, the different training and testing steps (and the data associated therewith) may be stored on the cloud computing environment 50 by the host platform 376. Each refinement of the machine learning model (e.g., changes in variables, weights, etc.) may be stored in the cloud computing environment 50 to provide verifiable proof of how the model was trained and what data was used to train the model. For example, the machine learning model may be stored on a blockchain to provide verifiable proof. Furthermore, when the host platform 376 has achieved a trained model, the resulting model may be stored on the cloud computing environment 50.

After the model has been trained, it may be deployed to a live environment where it can make predictions/decisions based on the execution of the final trained machine learning model. For example, in 374, the machine learning model may be used for condition-based maintenance (CBM) for an asset such as an aircraft, a wind turbine, a healthcare machine, and the like. In this example, data fed back from asset 378 may be input into the machine learning model and used to make event predictions such as failure events, error codes, and the like. Determinations made by the execution of the machine learning model at the host platform 376 may be stored on the cloud computing environment 50 to provide auditable/verifiable proof. As one non-limiting example, the machine learning model may predict a future breakdown/failure to a part of the asset 378 and create an alert or a notification to replace the part. The data behind this decision may be stored by the host platform 376 and/or on the cloud computing environment 50. In one embodiment the features and/or the actions described and/or depicted herein can occur on or with respect to the cloud computing environment 50.

FIG. 3E illustrates an example 380 of a quantum-secure cloud computing environment 382, which implements quantum key distribution (QKD) to protect against a quantum computing attack. In this example, cloud computing users can verify each other's identities using QKD. This sends information using quantum particles such as photons, which cannot be copied by an eavesdropper without destroying them. In this way, a sender, and a receiver through the cloud computing environment can be sure of each other's identity.

In the example of FIG. 3E, four users are present 384, 386, 388, and 390. Each pair of users may share a secret key 392 (i.e., a QKD) between themselves. Since there are four nodes in this example, six pairs of nodes exist, and therefore six different secret keys 392 are used including QKD_{AB}, QKD_{AC}, QKD_{AD}, QKD_{BC}, QKD_{BD}, and QKD_{CD}. Each pair can create a QKD by sending information using quantum particles such as photons, which cannot be copied by an eavesdropper without destroying them. In this way, a pair of users can be sure of each other's identity.

The operation of the cloud computing environment 382 is based on two procedures (i) creation of transactions, and (ii) construction of blocks that aggregate the new transactions. New transactions may be created similar to a traditional network, such as a blockchain network. Each transaction may contain information about a sender, a receiver, a time of creation, an amount (or value) to be transferred, a list of reference transactions that justifies the sender has funds for the operation, and the like. This transaction record is then sent to all other nodes where it is entered into a pool of unconfirmed transactions. Here, two parties (i.e., a pair of users from among 384-390) authenticate the transaction by providing their shared secret key 392 (QKD). This quantum signature can be attached to every transaction making it exceedingly difficult to be tampered with. Each node checks its entries with respect to a local copy of the cloud computing environment 382 to verify that each transaction has sufficient funds.

Conventional methods for training a time-series forecasting model involve three data subsets including a training subset, a validation subset, and a test subset. The training process involves iteratively executing the time-series forecasting model on the training subset until the model reaches a point where it can be validated. The training tries to optimize the parameters of the model (e.g., weights of a neural network, etc.) Meanwhile, hyperparameter optimization, also referred to herein as HPO, attempts to find a suitable set of hyperparameters that are generally not optimized during training.

Hyperparameters refer to configurations that are external to the machine-learning algorithm and have a value that cannot be estimated from the data (e.g., a number of hidden layer within a neural network, learning rate of a neural network, C and sigma parameters in support vector machines, the value of “k” in k-nearest neighbors algorithm, etc.) Conventional hyperparameter optimization for hierarchical time series forecaster training involves choosing a held-out validation time period from the data where the trained model's performance is evaluated and by optimizing that validation performance the hyperparameters of the model are selected. However, this process uses only the lowest-level of time-series for training and does not consider how upper-level time-series may affect the model. Meanwhile, in the example embodiments, a teacher model that is trained on upper-level time-series data may be used to optimize/modify the hyperparameters of a student model which is trained on the lowest-level time-series data.

FIG. 4A illustrates a process 400A of training a student model 411 and a plurality of teacher models 412, 413, and 414, of a time-series forecasting model according to example embodiments. Referring to FIG. 4A, a host platform, such as a cloud platform may deploy the student model 411 and the plurality of teacher models 412, 413, and 414 in a runtime environment of the host platform. The student model 411 may include a time-series forecasting algorithm (e.g., a machine learning algorithm) that is configured to make predictions on future values/observations of a time-series data value based on historical patterns of the time-series data value. Meanwhile, the plurality of teacher models 412, 413, and 414 also include a time-series forecasting algorithm. Each of the teacher models may have the same time-series forecasting algorithm as each other, or they may be different. Also, the teacher models may have the same time-series forecasting algorithm as the student model 411, or it may be different.

As an example, the models may be deployed in a cluster of servers. Furthermore, containerized images may be used used in the deployment. For example, each model may include its own container with the necessary testing data, validation data, storage locations for reading and writing the data, and the like. The code for the models may be written in any desired programming language such as Python, Spark, or the like. Internally, the framework may use distributed computing.

In the example of FIG. 4A, the hierarchical data set includes four levels/hierarchies of data including a root level (level 1), followed by a next level (level 2), followed by a next intermediate level (level 3), followed by a last level or leaf level (level 4). In this example, the student model 411 is trained on the lowest-level time-series data 401 (i.e. level 4). Meanwhile, the plurality of teacher models 412, 413, and 414, include three different time-series forecasting algorithms. Also, in this example, each of the teacher models are trained on different upper levels of time-series data from a hierarchical time-series data set. For example, teacher model 412 is trained based on level 1 data 402 (root level) from the time-series hierarchical data set, teacher model 413 is trained based on level 2 data 403 (intermediate level) from the time-series hierarchical data set, and teacher model 414 is trained based on level 3 data 404 (another intermediate level) from the time-series hierarchical data set.

The training process may involve iteratively executing the respective models until a desired model is reached. For example, training may be performed until a predetermined level of accuracy is reached or a predetermined amount of data has been input to the model. The result is an initially trained student model 421, and initially-trained teacher models 422, 423, and 424, respectively.

In this example, the teacher model(s) are trained on higher-level time series data. Furthermore, the teacher models may be executed on test data to generate teacher outputs which can be used as a proxy forecast (i.e., proxy for ground truth, etc.) to the (unknown) future at higher levels when optimizing the hyperparameter of the student model. In this case, it may be easier to model the higher level time series due to better coherence and predictability. Thus, the student model may receive knowledge from the teacher model in the form of hyperparameter optimizations such as learning cycles, number of hidden layers in a deep learning neural network, and any other hyperparameter values useful in a time-series forecasting model.

The student model is trained on the lowest-level time series (which is generally more incoherent and sparse), but do the hyperparameter optimization (HPO) of the student model based on the proxy forecast of the teacher model, the student model ends up becoming a more well-rounded model with learned model/algorithm parameter attributes from the lowest-level of the hierarchical time-series data set, and learned hyperparameters attributes from the upper-level(s) of the hierarchical time-series data set. Once the training of the student model is finished, the teacher model(s) may not be used.

FIG. 4B illustrates a process 400B of optimizing hyperparameters of the initially-trained student model 421 based on predicted outputs from the plurality of trained teacher models 422, 423, and 424. According to various embodiments, the optimization may be performed using a bottom-up aggregation. In this example, the initially-trained student model 421 may execute on a test data set 430 to generate a predicted result. In this example, the initially-trained student model 421 executes on different levels of a hierarchy of the time-series data in the test data set 430. In particular, the initially-trained student model 421 may generate a first predicted output 441 based on a highest level (level 1) of the hierarchical time-series data, a second predicted output 442 based on a second level (level 2) of the hierarchical time-series data set, and a third predicted output 443 on a third level (level 3) of the hierarchical time-series set. The initially-trained student model 421 may generate these aggregated forecasts 441, 442, and 443 at higher-levels by bottom-up aggregation method which sums up the children's forecast to get a forecast value at a parent node.

Meanwhile, the trained teacher model 422 may generate a predicted output 451 based on the highest level (level 1) of the hierarchical data in the time-series data set, the trained teacher model 423 may generate a predicted output 452 based on the next level (level 2) of the hierarchical time-series data set, and the trained teacher model 424 may generate a predicted output 453 based on the next level (level 3) of the hierarchical time-series data set. Here, the predicted outputs for the different hierarchical levels of data in the hierarchical time-series data set may be used to optimize the model parameters using a soft HKD objective.

Next, the predicted output 441 from the initially-trained student model 421 can be compared to the predicted output 451 of the trained teacher model 422, and a result of the comparison may cause the host platform to adjust one or more hyperparameters of the initially-trained student model 421. Likewise, the predicted output 442 from the initially-trained student model 421 can be compared to the predicted output 452 of the trained teacher model 423, and a result of the comparison may cause the host platform to adjust one or more hyperparameters of the initially-trained student model 421. Furthermore, the predicted output 443 from the initially-trained student model 421 can be compared to the predicted output 453 of the trained teacher model 424, and a result of the comparison may cause the host platform to adjust one or more hyperparameters of the initially-trained student model 421. The resulting hyperparameter optimization(s) results in a fully-trained student model. The fully-trained student model can then be deployed and used in a live environment such as a live runtime environment operated by the host platform.

This HKD approach will be very effective when the teacher predictions are very accurate (because the host may use teacher predictions as a proxy ground truth). However, it can lead to performance degradation when the teacher predictions are not reliable. To address this a “soft HKD objective” can be used where instead of using point predictions on an individual basis, the host relies on prediction distributions over time to compute the HKD objective and perform HPO. Also, the host may relatively weigh teacher proxies across different hierarchical levels of data based on a prediction interval width.

In particular, the host platform may optimize hyperparameters of the initially-trained student model based on proxy forecasts by the trained teacher models which are taken as an estimate of ground truth by the host platform. Teacher predictions may not be accurate on a point (mean) basis. Instead, the host platform may use a forecast distribution based on multiple forecasts from the same teacher model or multiple forecasts from multiple different teacher models. A distributional divergence may be determined by comparing the predicted output of the teacher model to the predicted output of the initially-trained student model. A soft object may be generated from the divergence between the teacher mode's forecast distribution and the aggregated forecast distribution of the student model on a bottom-up approach. The aggregation may be performed using a sample-wise aggregation pattern of the student model's forecasts or some other distributional assumption like Normal or Poisson.

Furthermore, the teacher models may be weighted differently based on factors such as reliability of the teacher models which may be determined by the host platform. For example, the hots platform may determine a reliability of a teacher model based on a width of its prediction interval, or the like.

Often the lowest-level time series data values are sparse and intermittent and do not capture prominent trend and seasonality patterns, hence, it is harder to train a time-series forecasting model on only the lowest-level of the time-series data. Furthermore, identifying the right validation set which highly mimics the test-data is very difficult.

These challenges makes the forecasting model training and hyperparameter optimization process a difficult process when targeted on lowest-level intermittent time-series. The models that are trained in this way are referred to herein as student models. Meanwhile, higher-level time-series data (e.g., aggregated time-series values from the lowest level) may have prominent trend and seasonality patterns, making it easier to capture them by directly building models targeted at higher level aggregated time-series. The models trained on higher level aggregated time-series are referred to herein as teacher models.

The host platform then employs a novel approach to robustly perform the hyperparameter optimization (HPO) of a student model by minimizing the hierarchical knowledge distillation (HKD) objective instead of minimizing the traditional held-out validation error at the lowest-level time-series. The HKD objective at a particular level is calculated by comparing the aggregated bottom-up predictions from the student model with the predictions from the teacher model(s) at that particular hierarchy level. This approach will be very effective when the teacher predictions are very accurate (because the host may use teacher predictions as a proxy ground truth). However, it can lead to performance degradation when the teacher predictions are not reliable. To address this the host platform may use a “soft HKD objective” where in instead of using point predictions, the host platform relies on prediction distributions to compute the HKD objective and perform HPO.

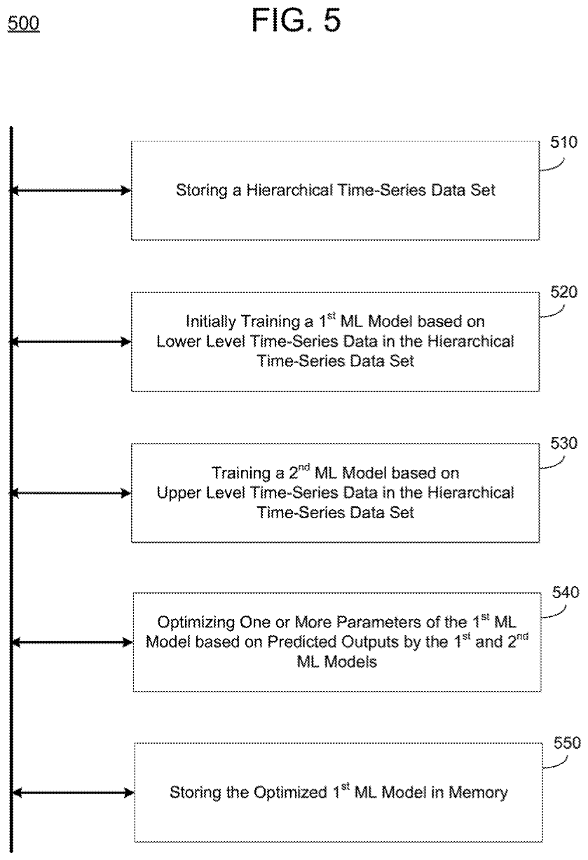

FIG. 5 illustrates a method 500 of training a time-series forecasting model according to an example embodiment. For example, the method 500 may be performed by a computer system such as a cloud platform, a web server, a personal computer or other user device, and the like. Referring to FIG. 5, in 510 the method may include storing a hierarchical time-series data set in memory. The hierarchical time-series data set may include a data value such as sales, quantity, or any other numerical value that can be broken up into different levels of aggregation and categorization.

In 520, the method may include initially training a first time-series forecasting model based on a lower level of time-series data in the hierarchical data set. In 530, the method may include training a second time-series teaching forecasting model based on an upper level of time-series data from the hierarchical data set which includes an additional level of aggregation with respect to the lower level of time-series data. In 540, the method may include optimizing one or more parameters of the initially trained first time-series forecasting model based on predicted outputs from the trained second time-series forecasting model in comparison to predicted outputs from the initially trained first time-series forecasting model. In 550, the method may include storing the optimized first time-series forecasting model in the memory.

In some embodiments, the optimizing may include modifying the one or more parameters based on a proxy for ground truth which is determined based on the predicted outputs of the trained second time-series forecasting model. In some embodiments, the optimizing may include executing the initially trained time-series forecasting model on the upper level of time-series data to generate a predicted output for the upper level of time-series data, and modifying the one or more parameters of the initially trained time-series forecasting model based on a predicted output generated by the trained second time-series forecasting model from the upper level of time-series data. In some embodiments, the first time-series forecasting model and the second time-series forecasting model include a same time-series algorithm. In some embodiments, the first time-series forecasting model and the second time-series forecasting model are a different time-series algorithm.

In some embodiments, the training the second time-series forecasting model may include training a plurality of second time-series forecasting models based on a plurality of upper levels of time-series data from the hierarchical data set, respectively, wherein the plurality of upper levels of time-series data include a plurality of additional levels of aggregation, respectively, with respect to the lower level of time-series data.

In some embodiments, the optimizing may include executing the initially-trained first time-series forecasting model on the plurality of upper levels of time-series data from the hierarchical data set to create a plurality of predicted outputs for the plurality of upper levels, and modifying the one or more parameters of the initially-trained first time-series forecasting model based on a plurality of predicted outputs by the plurality of trained second time-series forecasting models for the plurality of upper levels, respectively.

In some embodiments, the optimizing may include optimizing the one or more parameters of the initially trained first time-series forecasting model based on a soft hierarchical knowledge distillation (HKD) objective function which is based on a divergence between a distribution of outputs predicted by the initially-trained first time-series forecasting model and a distribution of outputs predicted by the trained second time-series forecasting model.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

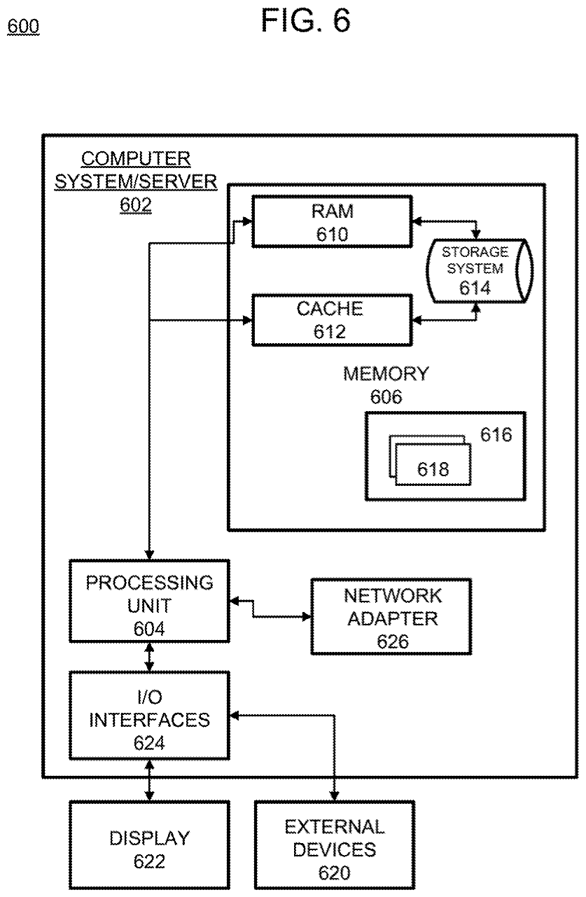

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example computer system architecture 600, which may represent or be integrated in any of the above-described components, etc.

FIG. 6 illustrates an example system 600 that supports one or more of the example embodiments described and/or depicted herein. The system 600 comprises a computer system/server 602, which is operational with numerous other general purpose or special purpose computing system environments or configurations. Examples of well-known computing systems, environments, and/or configurations that may be suitable for use with computer system/server 602 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 602 in cloud computing node 600 is shown in the form of a general-purpose computing device. The components of computer system/server 602 may include, but are not limited to, one or more processors or processing units 604, a system memory 606, and a bus that couples various system components including system memory 606 to processor 604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media. System memory 606, in one embodiment, implements the flow diagrams of the other figures. The system memory 606 can include computer system readable media in the form of volatile memory, such as random-access memory (RAM) 610 and/or cache memory 612. Computer system/server 602 may further include other removable/non-removable, volatile/non-volatile computer system storage media. By way of example only, storage system 614 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 606 may include at least one program product having a set (e.g., at least one) of program modules that are configured to carry out the functions of various embodiments of the application.

Program/utility 616, having a set (at least one) of program modules 618, may be stored in memory 606 by way of example, and not limitation, as well as an operating system, one or more application programs, other program modules, and program data. Each of the operating system, one or more application programs, other program modules, and program data or some combination thereof, may include an implementation of a networking environment. Program modules 618 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 602 may also communicate with one or more external devices 620 such as a keyboard, a pointing device, a display 622, etc.; one or more devices that enable a user to interact with computer system/server 602; and/or any devices (e.g., network card, modem, etc.) that enable computer system/server 602 to communicate with one or more other computing devices. Such communication can occur via I/O interfaces 624. Still yet, computer system/server 602 can communicate with one or more networks such as a local area network (LAN), a general wide area network (WAN), and/or a public network (e.g., the Internet) via network adapter 626. As depicted, network adapter 626 communicates with the other components of computer system/server 602 via a bus. It should be understood that although not shown, other hardware and/or software components could be used in conjunction with computer system/server 602. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. An apparatus comprising:
a memory configured to store a hierarchical time-series data set; and
a processor configured to
initially train a first time-series forecasting model based on a lower level of time-series data in the hierarchical data set;
train a second time-series teaching forecasting model based on an upper level of time-series data from the hierarchical data set which includes an additional level of aggregation with respect to the lower level of time-series data;
optimize one or more parameters of the initially trained first time-series forecasting model based on predicted outputs from the trained second time-series forecasting model in comparison to predicted outputs from the initially trained first time-series forecasting model; and
store the optimized first time-series forecasting model in the memory.

2. The apparatus of claim 1, wherein the processor is configured to modify the one or more parameters based on a proxy for ground truth which is determined based on the predicted outputs of the trained second time-series forecasting model.

3. The apparatus of claim 1, wherein the processor is configured to execute the initially trained time-series forecasting model on the upper level of time-series data to generate a predicted output for the upper level of time-series data, and modify the one or more parameters of the initially trained time-series forecasting model based on a predicted output generated by the trained second time-series forecasting model from the upper level of time-series data.

4. The apparatus of claim 1, wherein the first time-series forecasting model and the second time-series forecasting model comprise a same time-series algorithm.

5. The apparatus of claim 1, wherein the first time-series forecasting model and the second time-series forecasting model comprise a different time-series algorithm.

6. The apparatus of claim 1, wherein the processor is configured to train a plurality of second time-series forecasting models based on a plurality of upper levels of time-series data from the hierarchical data set, respectively, wherein the plurality of upper levels of time-series data include a plurality of additional levels of aggregation, respectively, with respect to the lower level of time-series data.

7. The apparatus of claim 6, wherein the processor is configured to execute the initially-trained first time-series forecasting model on the plurality of upper levels of time-series data from the hierarchical data set to create a plurality of predicted outputs for the plurality of upper levels, and modify the one or more parameters of the initially-trained first time-series forecasting model based on a plurality of predicted outputs by the plurality of trained second time-series forecasting models for the plurality of upper levels, respectively.

8. The apparatus of claim 1, wherein the processor is configured to optimize the one or more parameters of the initially trained first time-series forecasting model based on a soft hierarchical knowledge distillation (HKD) objective function which is based on a divergence between a distribution of outputs predicted by the initially-trained first time-series forecasting model and a distribution of outputs predicted by the trained second time-series forecasting model.

9. A method comprising:
storing a hierarchical time-series data set in memory;
initially training a first time-series forecasting model based on a lower level of time-series data in the hierarchical data set;
training a second time-series teaching forecasting model based on an upper level of time-series data from the hierarchical data set which includes an additional level of aggregation with respect to the lower level of time-series data;
optimizing one or more parameters of the initially trained first time-series forecasting model based on predicted outputs from the trained second time-series forecasting model in comparison to predicted outputs from the initially trained first time-series forecasting model; and
storing the optimized first time-series forecasting model in the memory.

10. The method of claim 9, wherein the optimizing comprises modifying the one or more parameters based on a proxy for ground truth which is determined based on the predicted outputs of the trained second time-series forecasting model.

11. The method of claim 9, wherein the optimizing comprises executing the initially trained time-series forecasting model on the upper level of time-series data to generate a predicted output for the upper level of time-series data, and modifying the one or more parameters of the initially trained time-series forecasting model based on a predicted output generated by the trained second time-series forecasting model from the upper level of time-series data.

12. The method of claim 9, wherein the first time-series forecasting model and the second time-series forecasting model comprise a same time-series algorithm.

13. The method of claim 9, wherein the first time-series forecasting model and the second time-series forecasting model comprise a different time-series algorithm.

14. The method of claim 9, wherein the training the second time-series forecasting model comprises training a plurality of second time-series forecasting models based on a plurality of upper levels of time-series data from the hierarchical data set, respectively, wherein the plurality of upper levels of time-series data include a plurality of additional levels of aggregation, respectively, with respect to the lower level of time-series data.

15. The method of claim 14, wherein the optimizing comprises executing the initially-trained first time-series forecasting model on the plurality of upper levels of time-series data from the hierarchical data set to create a plurality of predicted outputs for the plurality of upper levels, and modifying the one or more parameters of the initially-trained first time-series forecasting model based on a plurality of predicted outputs by the plurality of trained second time-series forecasting models for the plurality of upper levels, respectively.

16. The method of claim 9, wherein the optimizing comprises optimizing the one or more parameters of the initially trained first time-series forecasting model based on a soft hierarchical knowledge distillation (HKD) objective function which is based on a divergence between a distribution of outputs predicted by the initially-trained first time-series forecasting model and a distribution of outputs predicted by the trained second time-series forecasting model.

17. A computer-readable storage medium comprising instructions, that when read by a processor, cause the processor to perform a method comprising:
storing a hierarchical time-series data set in memory;
initially training a first time-series forecasting model based on a lower level of time-series data in the hierarchical data set;
training a second time-series teaching forecasting model based on an upper level of time-series data from the hierarchical data set which includes an additional level of aggregation with respect to the lower level of time-series data;
optimizing one or more parameters of the initially trained first time-series forecasting model based on predicted outputs from the trained second time-series forecasting model in comparison to predicted outputs from the initially trained first time-series forecasting model; and
storing the optimized first time-series forecasting model in the memory.

18. The computer-readable storage medium of claim 17, wherein the optimizing comprises modifying the one or more parameters based on a proxy for ground truth which is determined based on the predicted outputs of the trained second time-series forecasting model.

19. The computer-readable storage medium of claim 17, wherein the optimizing comprises executing the initially trained time-series forecasting model on the upper level of time-series data to generate a predicted output for the upper level of time-series data, and modifying the one or more parameters of the initially trained time-series forecasting model based on a predicted output generated by the trained second time-series forecasting model from the upper level of time-series data.

20. The computer-readable storage medium of claim 17, wherein the first time-series forecasting model and the second time-series forecasting model comprise a same time-series algorithm.
